(19) United States
(12) Patent Application Publication
(10) Pub. No.: US 2022/0187654 A1
(43) Pub. Date: Jun. 16, 2022

(54) DISPLAY PANEL, DISPLAY DEVICE THEREOF, AND MOBILE TERMINAL

(71) Applicant: Wuhan China Star Optoelectronics Technology Co., Ltd., Wuhan (CN)

(72) Inventor: Jun LUO, Wuhan (CN)

(21) Appl. No.: 16/615,847

(22) PCT Filed: Oct. 14, 2019
(86) PCT No.: PCT/CN2019/110958

§ 371 Date: Nov. 22, 2019

(30) Foreign Application Priority Data
Aug. 22, 2019 (CN) 201910777747.0

(51) Int. Cl. G02F 1/1335; G02F 1/1337; G02F 1/1339

(52) U.S. Cl. CPC G02F 1/133512; G02F 1/1339; G02F 1/133723

(57) ABSTRACT

The present disclosure relates to a display panel, a display device thereof, and a mobile terminal. The display panel is defined with a display area and a camera area, wherein a closed accommodating space is formed in the camera area through a first substrate layer, a second substrate layer, and a frame glue. Besides, a first liquid crystal layer is formed by filling a liquid crystal material in the accommodating space, thereby preventing gravity or nonuniform box thickness caused by a difference in thickness of the liquid crystal cell, preventing opening holes on the display panel, and protecting integrity of the display panel. Therefore, poor chemical resistance of the display panel and imperfect visual effect of the full screen can be prevented.

### FIELD OF INVENTION

The present disclosure relates to the field of display technologies, and more particularly, to a display panel, a display device thereof, and a mobile terminal.

### BACKGROUND OF INVENTION

Display devices can convert computer data into various characters, numbers, symbols, or intuitive images, and can input commands or data into computers by using an input tool such as a keyboard, and can add, modify, and change display contents at any time by means of hardware and software of the system. Display devices are classified into types of plasma, liquid crystals, light emitting diodes, and cathode ray tubes depending on a display device used.

Liquid crystal displays (LCDs) are based on a liquid crystal material, and are filled with the liquid crystal material between two parallel plates to change alignment of inner molecules in the liquid crystal material by voltages, thereby achieving an object of light shading and light transmission to display different shades, obtaining a patchwork image, and realizing displaying a color image by adding a ternary color filter layer between the two plates.

Presently, mainstream LCDs are thin film transistor liquid crystal displays (TFT-LCDs), which are developed from original liquid crystal display technology. In a TFT-LCD active liquid crystal display, each sub-pixel has a TFT having a gate electrode connected to a horizontal scanning line, a drain electrode connected to a vertical data line, and a source electrode connected to a pixel electrode. Applying a sufficient voltage on the horizontal scanning line causes all the TFTs on the horizontal scanning line to be turned on. At this time, the pixel electrodes on the horizontal scanning line are connected to the data lines in the vertical direction that display signal voltage on the data lines is written into the pixels, and a rotation direction of the liquid crystal molecules is controlled by signal and voltage changes on the TFT, thereby controlling emission of polarized light in each pixel to achieve an objective to display. An TFT liquid crystal is provided with a semiconductor switch for each pixel, that completely control one pixel point alone. An liquid crystal material is sandwiched between a TFT glass layer and a color filter layer, and rotation directions of liquid crystal molecules are controlled by changing stimulating voltage values of liquid crystal, thereby controlling whether the polarized light of each pixel is emitted or not to achieve an objective to display, and controlling intensity and color of the last appearing light.

Technical problem: in order to pursue perfect visual effects, an extreme frame for a full screen has become a future development trend of the mobile terminal. At present, regarding a front camera placement of mobile phones, current mainstream technology is to design a notch, a water droplet, or a widow's peak on the screen. This technique requires through-holes in the display panel, which destroys integrity of the display panel, thereby causing poor chemical resistance of the display panel itself, and imperfect visual effect of the full screen. Therefore, a new type of display panel is needed to solve the above problems.

### SUMMARY OF INVENTION

An object of the present disclosure is to provide a display panel, a display device thereof, and a mobile terminal to prevent through-holes in the display panel, and to protect the integrity of the display panel, thereby preventing poor chemical resistance of the display panel itself and imperfect visual effect of the full screen.

To solve the above problem, an embodiment of the present disclosure provides a display panel which is defined with a display area and a camera area. The display panel comprises a first substrate, a second substrate, a first substrate layer, a planarization layer, and a second substrate layer. Wherein the second substrate is disposed correspondingly on the first substrate, the first substrate layer is disposed on a surface of the first substrate facing the second substrate, the planarization layer is disposed on a surface of the second substrate facing the first substrate, and the second substrate layer is disposed on a surface of the planarization layer facing the first substrate. Wherein the display panel in the camera area further comprises: frame glue and a first liquid crystal layer. Wherein the frame glue is disposed between the first substrate layer and the second substrate layer, and is combined with the first substrate layer and the second substrate layer to form a closed accommodating space. The first liquid crystal layer is formed by filling a liquid crystal material in the accommodating space.

In an embodiment of the present disclosure, the display panel in the display area further comprises: a functional layer, a second liquid crystal layer, a support column, and a black matrix. Wherein the functional layer is disposed on the first substrate layer, the second liquid crystal layer is formed by filling a liquid crystal material between the functional layer and the second substrate layer, the support column is disposed on a surface of the second substrate layer facing the first substrate, and the black matrix is disposed between the planarization layer and the second substrate.

In an embodiment of the present disclosure, the functional layer comprises an active layer, a gate insulation layer, an interlayer insulation layer, a planar layer, a first dielectric layer, and a second dielectric layer. The active layer is disposed on the first substrate layer, the gate insulation layer is disposed on the active layer, the interlayer insulation layer is disposed on the gate insulation layer, the planar layer is disposed on the interlayer insulation layer, the first dielectric layer is disposed on the planar layer, and the second dielectric layer is disposed on the first dielectric layer.

In an embodiment of the present disclosure, a constituent material of the first substrate layer and the second substrate layer comprises polyimide.

In an embodiment of the present disclosure, a constituent material of the active layer comprises one or more SiNx, SiOx, or combinations thereof.

In an embodiment of the present disclosure, a constituent material of the gate insulation layer comprises SiOx.

In an embodiment of the present disclosure, a constituent material of the interlayer insulation layer comprises one or more SiNx, SiOx, or combinations thereof.

In an embodiment of the present disclosure, a planar shape of the camera area comprises one or more circles, rectangles, ovals, or combinations thereof.

Another embodiment of the present disclosure further provides a display device. The display device comprises the display panel of the present disclosure. The display device further comprises a camera element disposed on one side of the first substrate away from the second substrate corresponding to the camera area.

Another embodiment of the present disclosure further provides a mobile terminal. The mobile terminal comprises the display device of the present disclosure.

The present disclosure relates to a display panel, a display device thereof, and a mobile terminal. The display panel is defined with a display area and a camera area, a closed accommodating space is formed through a first substrate layer, a second substrate layer and frame glue, and a first liquid crystal layer is formed by filling a liquid crystal material in the space, thereby preventing gravity or nonuniform box thickness caused by a difference in thickness of the liquid crystal cell between the first liquid crystal layer and the second liquid crystal layer. On the other hand, a camera element is disposed on one side of the first substrate away from the second substrate corresponding to the camera area, and the display panel in the camera area is a transparent visible area with respect to the camera element, thereby preventing through-holes on the display panel and protecting integrity of the display panel. Therefore, poor chemical resistance of the display panel itself and imperfect visual effect of the full screen can be prevented.

### DESCRIPTION OF DRAWINGS

The accompanying figures to be used in the description of embodiments of the present disclosure or prior art will be described in brief to more clearly illustrate the technical solutions of the embodiments or the prior art. The accompanying figures described below are only part of the embodiments of the present disclosure, from which those skilled in the art can derive further figures without making any inventive efforts.

FIG. 1 is a schematic plan diagram of a display panel of the present disclosure.

FIG. 2 is a schematic structural diagram of a display panel of the present disclosure.

FIG. 3 is a schematic structural diagram of a display device of the present disclosure.

### DETAILED DESCRIPTION OF PREFERRED EMBODIMENTS

The preferred embodiments of the present disclosure are described in detail below with reference to the accompanying drawings. The specific embodiments described with reference to the attached drawings are all exemplary and are intended to illustrate and interpret the present disclosure to make the skilled in the art easier to understand how to implement the present disclosure. The disclosure herein provides many different embodiments or examples for realizing different structures of the present disclosure. They are only examples and are not intended to limit the present disclosure.

In the description of the present disclosure, it should be understood that terms such as “upper”, “lower”, “front”, “rear”, “left”, “right”, “inside”, “outside”, “side”, as well as derivative thereof should be construed to refer to the orientation as described or as shown in the drawings under discussion. These relative terms are for convenience of description, do not require that the present disclosure be constructed or operated in a particular orientation, and shall not be construed as causing limitations to the present disclosure.

In the accompanying drawings, wherein the identical or similar reference numerals constantly denote the identical or similar elements or elements having the identical or similar functions. In the drawings, structurally identical components are denoted by the same reference numerals, and structural or functionally similar components are denoted by like reference numerals. Moreover, a size and a thickness of each component shown in the drawings are arbitrarily shown for ease of understanding and description, and the present disclosure does not limit the size and thickness of each component.

When a component is described as “on” another component, the component can be placed directly on the other component; an intermediate component can also exist, the component is placed on the intermediate component, and the intermediate component is placed on another component. When a component is described as “installed to” or “connected to” another component, it can be understood as directly “installed to” or “connected to”, or a component is “mounted to” or “connected to” another component through an intermediate component.

### Embodiment 1

As shown in FIG. 1, a display panel 100 is defined with a display area 101 and a camera area 102. A planar shape of the camera area 102 comprises one or more circles, rectangles, ovals, or combinations thereof. The planar shape of the camera area 101 in this embodiment is a circle. The camera area 102 can be disposed at any position of the display panel 100. In this embodiment, the camera area 102 is disposed at the upper left corner of the display panel 100.

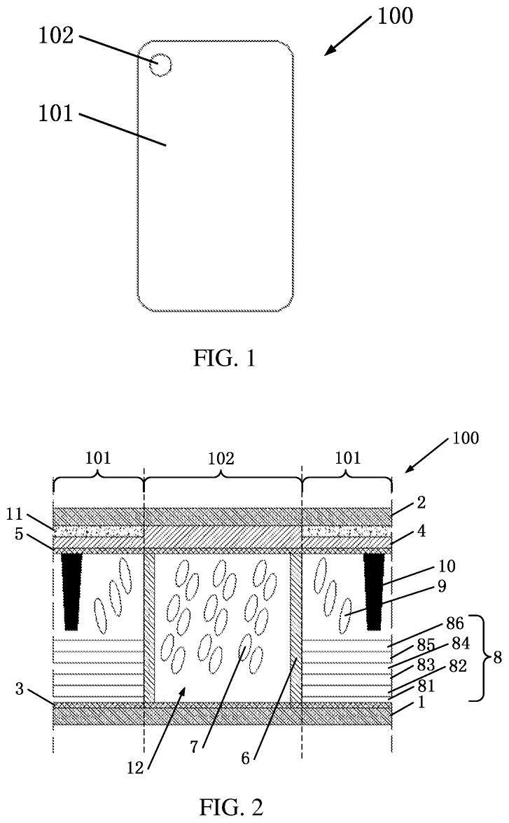

As shown in FIG. 2, the display panel 100 includes: a first substrate 1, a second substrate 2, a first substrate layer 3, a planarization layer 4, and a second substrate layer 5.

As shown in FIG. 2, wherein the second substrate 2 is disposed correspondingly on the first substrate 1, the first substrate layer 3 is disposed on a surface of the first substrate 1 facing the second substrate 2, the planarization layer 4 is disposed on a surface of the second substrate 2 facing the first substrate 1, and the second substrate layer 5 is disposed on a surface of the planarization layer 4 facing the first substrate 1.

Glass can be selected as a constituent material of the first substrate 1 and the second substrate 2, thereby transmittance may be improved.

A constituent material of the first substrate layer 3 and the second substrate layer 5 comprises polyimide. The first substrate layer 3 and the second substrate layer 5 are mainly used as alignments for allowing liquid crystals to be arranged in an orderly manner.

A transparent material may be selected as a constituent material of the planarization layer 4, thereby preventing affecting light transmittance, achieving leveling effect, and reducing steering resistance of liquid crystals.

The display panel 100 in the camera area 102 further comprises: frame glue 6 and a first liquid crystal layer 7. Wherein the frame glue 6 is disposed between the first substrate layer 3 and the second substrate layer 5, and is combined with the first substrate layer 3 and the second substrate layer 5 to form a closed accommodating space 12. The first liquid crystal layer 7 is formed by filling a liquid crystal material in the accommodating space 12.

Therefore, gravity or non-uniform box thickness caused by a difference in thickness of the liquid crystal cell between the first liquid crystal layer 7 and the second liquid crystal layer 9 can be prevented. Therefore, a camera element 200 can be disposed under the first substrate 1 corresponding to the camera area 102, and the display panel 100 in the camera area 102 is a transparent visible area with respect to the camera element 200, thereby preventing opening holes on the display panel 100, protecting the integrity of the display panel 100, and preventing poor chemical resistance of the display panel 100 itself, and imperfect visual effect of the full screen.

As shown in FIG. 2, the display panel 100 in the display area 101 further comprises: a functional layer 8, a second liquid crystal layer 9, a support column 10, and a black matrix 11.

As shown in FIG. 2, the functional layer 8 is disposed on the first substrate layer 3. The functional layer 8 comprises: an active layer 81, a gate insulation layer 82, an interlayer insulation layer 83, a planar layer 84, a first dielectric layer 85, and a second dielectric layer 86. The active layer 81 is disposed on the first substrate layer 3, the gate insulation layer 82 is disposed on the active layer 81, the interlayer insulation layer 83 is disposed on the gate insulation layer 82, the planar layer 84 is disposed on the interlayer insulation layer 83, the first dielectric layer 85 is disposed on the planar layer 84, and the second dielectric layer 86 is disposed on the first dielectric layer 85.

The constituent material of the active layer 81 comprises one or more SiNx, SiOx, or combinations thereof. The constituent material of the gate insulation layer 82 comprises SiOx. In fact, a gate electrode layer (not shown) is further disposed between the gate insulation layer 82 and the interlayer insulation layer 83, and the gate insulation layer 82 is mainly used to prevent contact between the gate electrode layer and the active layer 81 that causes short circuit and affects the imaging effect. Therefore, the gate insulation layer 82 is formed to have a good insulation effect.

Wherein, the constituent material of the interlayer insulation layer 83 comprises one or more SiNx, SiOx, or combinations thereof. In fact, a source/drain electrode layer (not shown) is further disposed between the interlayer insulation layer 83 and the planar layer 84. The interlayer insulation layer 83 is mainly used to prevent contact between the source/drain electrode layer and the gate electrode layer that causes short circuit and affects the imaging effect. Therefore, the gate insulation layer 83 is formed to have a good insulation effect.

Wherein, the constituent material of the first dielectric layer 85 and the second dielectric layer 86 comprises SiNx. The first dielectric layer 85 and the second dielectric layer 86 are mainly used as dielectric protection between the capacitor plates and the metal electrodes to prevent affecting imaging.

The planar layer 84 is mainly used for leveling, which facilitates subsequent structure preparation.

As shown in FIG. 2, the second liquid crystal layer 9 is formed by filling a liquid crystal material between the functional layer 8 and the second substrate layer 5.

As shown in FIG. 2, the support column 10 is disposed on a surface of the second substrate layer 5 facing the first substrate 1. The support column 10 is used mainly for supporting, so that there is a gap between the second substrate layer 5 and the functional layer 8 for filling the liquid crystal material and forming a second liquid crystal layer 9.

As shown in FIG. 2, the black matrix 11 is disposed between the planarization layer 4 and the second substrate 2. The black matrix 11 is mainly used to prevent light leakage, improve display contrast, prevent color mixing, and increase color purity.

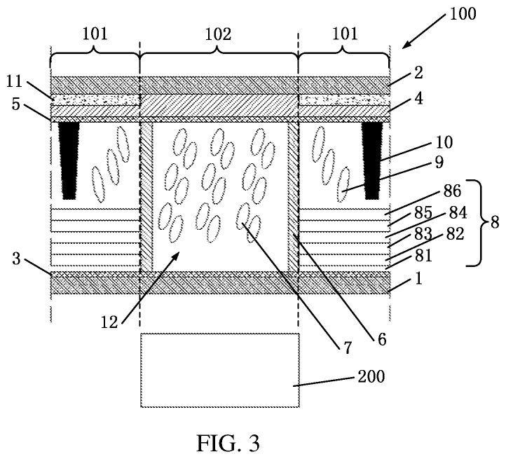

As shown in FIG. 3, an embodiment of the present disclosure also provides a display device including the display panel 100 according to the present disclosure. The display device further comprises the camera element 200, and the camera element 200 is disposed on one side of the first substrate 1 away from the second substrate 2 corresponding to the camera area 102. Therefore, the display panel 100 in the camera area 102 is a transparent visible area with respect to the camera element 200, thereby preventing opening holes on the display panel 100, protecting the integrity of the display panel 100, and preventing poor chemical resistance of the display panel 100 itself, and imperfect visual effect of the full screen.

Another embodiment of the present disclosure further provides a mobile terminal. The mobile terminal comprises the display device of the present disclosure. The mobile terminal comprises one or more of the followings: a mobile phone, a tablet computer, and a notebook computer.

The display panel, the display device thereof, and the mobile terminal provided by the present disclosure are described in detail above. The disclosure herein provides many different embodiments or examples for realizing different structures of the present disclosure, and it is understood that they are only examples and are not intended to limit the present disclosure. Descriptions of features or aspects in each exemplary embodiment should generally be considered as suitable features or aspects in other exemplary embodiments. While the disclosure has been described with reference to the preferred embodiments thereof, various modifications and changes can be made by those skilled in the art. It is understood that many changes and modifications to the described embodiment can be carried out without departing from the scope and the spirit of the disclosure that is intended to be limited only by the appended claims.

What is claimed is:

1. A display panel defined with a display area and a camera area, comprising:
a first substrate;
a second substrate disposed correspondingly on the first substrate;
a first substrate layer disposed on a surface of the first substrate facing the second substrate;
a planarization layer disposed on a surface of the second substrate facing the first substrate; and
a second substrate layer disposed on a surface of the planarization layer facing the first substrate;
the display panel in the camera area further comprising:
frame glue disposed between the first substrate layer and the second substrate layer, the frame glue combined with the first substrate layer and the second substrate layer to form a closed accommodating space; and
a first liquid crystal layer formed by filling a liquid crystal material in the accommodating space.

2. The display panel according to claim 1, wherein the display panel in the display area further comprises:
a functional layer disposed on the first substrate layer;
a second liquid crystal layer formed by filling the liquid crystal material between the functional layer and the second substrate layer;
a support column disposed on a surface of the second substrate layer facing the first substrate; and
a black matrix disposed between the planarization layer and the second substrate.

3. The display panel according to claim 2, wherein the functional layer comprises:
an active layer disposed on the first substrate layer;
a gate insulation layer disposed on the active layer;
an interlayer insulation layer disposed on the gate insulation layer;
a planar layer disposed on the interlayer insulation layer;
a first dielectric layer disposed on the planar layer; and
a second dielectric layer disposed on the first dielectric layer.

4. The display panel according to claim 1, wherein a constituent material of the first substrate layer and the second substrate layer comprises polyimide.

5. The display panel according to claim 3, wherein a constituent material of the active layer comprises one or more SiNx, SiOx, or combinations thereof.

6. The display panel according to claim 3, wherein a constituent material of the gate insulation layer comprises SiOx.

7. The display panel according to claim 3, wherein a constituent material of the interlayer insulation layer comprises one or more SiNx, SiOx, or combinations thereof.

8. The display panel according to claim 1, wherein a planar shape of the camera area comprises one or more circles, rectangles, ovals, or combinations thereof.

9. A display device, comprising a display panel defined with a display area and a camera area, wherein the display panel comprises:
a first substrate;
a second substrate disposed correspondingly on the first substrate;
a first substrate layer disposed on a surface of the first substrate facing the second substrate;
a planarization layer disposed on a surface of the second substrate facing the first substrate; and
a second substrate layer disposed on a surface of the planarization layer facing the first substrate;
the display panel in the camera area further comprising:
frame glue disposed between the first substrate layer and the second substrate layer, the frame glue combined with the first substrate layer and the second substrate layer to form a closed accommodating space; and
a first liquid crystal layer formed by filling a liquid crystal material in the accommodating space.

10. The display device according to claim 9, wherein the display panel in the display area further comprises:
a functional layer disposed on the first substrate layer;
a second liquid crystal layer formed by filling the liquid crystal material between the functional layer and the second substrate layer;
a support column disposed on a surface of the second substrate layer facing the first substrate; and
a black matrix disposed between the planarization layer and the second substrate.

11. The display device according to claim 10, wherein the functional layer comprises:
an active layer disposed on the first substrate layer;
a gate insulation layer disposed on the active layer;
an interlayer insulation layer disposed on the gate insulation layer;
a planar layer disposed on the interlayer insulation layer;
a first dielectric layer disposed on the planar layer; and
a second dielectric layer disposed on the first dielectric layer.

12. The display device according to claim 9, wherein a constituent material of the first substrate layer and the second substrate layer comprises polyimide.

13. The display device according to claim 11, wherein a constituent material of the active layer comprises one or more SiNx, SiOx, or combinations thereof.

14. The display device according to claim 11, wherein a constituent material of the gate insulation layer comprises SiOx.

15. The display device according to claim 11, wherein a constituent material of the interlayer insulation layer comprises one or more SiNx, SiOx, or combinations thereof.

16. The display device according to claim 9, wherein a planar shape of the camera area comprises one or more circles, rectangles, ovals, or combinations thereof.

17. The display device according to claim 9, further comprising a camera element disposed on one side of the first substrate away from the second substrate corresponding to the camera area.

18. A mobile terminal, comprising the display device according to claim 9.
